(19) United States
(12) Patent Application Publication
(10) Pub. No.: US 2023/0064893 A1
(43) Pub. Date: Mar. 2, 2023

(54) ELECTROCATALYST LAYER DECAL

(71) Applicant: JOHNSON MATTHEY HYDROGEN TECHNOLOGIES LIMITED, London (GB)

(72) Inventors: Jake COOLE, Swindon, Wiltshire (GB); Angus DICKINSON, Swindon, Wiltshire (GB); Julie O'SULLIVAN, Swindon, Wiltshire (GB); Satu PIETILA, Swindon, Wiltshire (GB)

(21) Appl. No.: 17/904,451

(22) PCT Filed: Apr. 22, 2021
(86) PCT No.: PCT/GB2021/050964

§ 371 Date: Aug. 17, 2022

(30) Foreign Application Priority Data
Apr. 23, 2020 (GB) 2005922.6

(51) Int. Cl. H01M 4/88; H01M 8/1004; H01M 8/0271

(52) U.S. Cl. CPC H01M 4/8814; H01M 4/8828; H01M 8/1004; H01M 8/0271

(57) ABSTRACT

The present invention provides a catalysed decal transfer substrate comprising a decal transfer substrate, an electrocatalyst later, and a layer D between the decal transfer substrate and the electrocatalyst layer which comprises an ion-conducting polymer and a carbon material. The layer D is configured such that, upon transfer of the electrocatalyst layer to a surface, at least a portion of the layer D remains attached to and is transferred with the electrocatalyst layer.

### FIELD OF THE INVENTION

The present invention provides a catalysed decal transfer substrate with an additional layer which allows marking of an electrocatalyst layer and facilitates the use of inexpensive decal transfer substrate materials.

### BACKGROUND OF THE INVENTION

A fuel cell is an electrochemical cell comprising two electrodes separated by an electrolyte. A fuel, e.g. hydrogen, an alcohol such as methanol or ethanol, or formic acid, is supplied to the anode and an oxidant, e.g. oxygen or air, is supplied to the cathode. Electrochemical reactions occur at the electrodes, and the chemical energy of the fuel and the oxidant is converted to electrical energy and heat. Electrocatalysts are used to promote the electrochemical oxidation of the fuel at the anode and the electrochemical reduction of oxygen at the cathode.

Fuel cells are usually classified according to the nature of the electrolyte employed. Often the electrolyte is a solid polymeric membrane, in which the membrane is electronically insulating but ionically conducting. In the proton exchange membrane fuel cell (PEMFC) the ion-conducting membrane is proton conducting, and protons, produced at the anode, are transported across the ion-conducting membrane to the cathode, where they combine with oxygen to form water.

A principal component of the PEMFC is the membrane electrode assembly, which is essentially composed of five layers. The central layer is the polymer ion-conducting membrane. On either face of the ion-conducting membrane there is an electrocatalyst layer, containing an electrocatalyst designed for the specific electrolytic reaction. Finally, adjacent to each electrocatalyst layer there is a gas diffusion layer. The gas diffusion layer must allow the reactants to reach the electrocatalyst layer and must conduct the electric current that is generated by the electrochemical reactions. Therefore, the gas diffusion layer must be porous and electrically conducting.

The electrocatalyst layers also generally comprise a proton conducting material, such as a proton conducting polymer, to aid transfer of protons from the anode electrocatalyst to the ion-conducting membrane and/or from the ion-conducting membrane to the cathode electrocatalyst.

Conventionally, membrane electrode assemblies can be constructed by a number of methods. Typically, the methods involve the application of one or both of the electrocatalyst layers to an ion-conducting membrane to form a catalyst coated ion-conducting membrane. Subsequently, a gas diffusion layer is applied to the electrocatalyst layer. Alternatively, an electrocatalyst layer is applied to a gas diffusion layer to form a gas diffusion electrode, which is then combined with the ion-conducting membrane. A membrane electrode assembly can be prepared by a combination of these methods e.g. one electrocatalyst layer is applied to the ion-conducting membrane to form a catalyst coated ion-conducting membrane, and the other electrocatalyst layer is applied as a gas diffusion electrode.

Electrocatalyst layers may be applied by a decal transfer process. Firstly, an electrocatalyst ink which conventionally comprises an electrocatalyst material, an ion-conducting polymer, solvents and/or diluents, and any agents desired to be included in the electrocatalyst layer, is applied to a decal transfer substrate and dried to provide a catalysed decal transfer substrate. Such a catalysed decal transfer substrate may then be stored, for example, as a roll-good material. The electrocatalyst layer is then applied to the desired substrate, e.g. an ion-conducting membrane to form a catalyst coated ion-conducting membrane, by decal transfer. The transfer may be facilitated, for example, by the use of heat or by heat and pressure.

### SUMMARY OF THE INVENTION

In a catalyst coated ion-conducting membrane containing two electrocatalyst layers on opposing faces of the membrane, it can be difficult to differentiate the two layers after the manufacturing process is complete. Accordingly, there is a need in the art for an effective way of marking one or both of the electrocatalyst layers without affecting electrochemical performance in a membrane electrode assembly. Moreover, decal transfer substrates can be expensive and thus contribute cost to the process. This is because the substrates are required to have a particular balance of properties which allow the substrates to carry and release the electrocatalyst layer, in some cases requiring the presence of an additional polymeric release layer, between the electrocatalyst layer and the substrate, to facilitate release.

Accordingly, in a first aspect the present invention provides a catalysed decal transfer substrate comprising:
i) a decal transfer substrate;
ii) an electrocatalyst layer A;
iii) a layer D between the decal transfer substrate and the electrocatalyst layer A; wherein

the layer D comprises an ion-conducting polymer and a carbon material, and

the layer D is configured such that, upon transfer of the electrocatalyst layer A to a surface, at least a portion of the layer D remains attached to and is transferred with the electrocatalyst layer A.

Accordingly, the electrocatalyst layer is marked, for example, by reflective or texture based means with the carbon material. Accordingly, it can be differentiated from an electrocatalyst layer present on the opposite face of an ion-conducting membrane. In addition, when only a portion of the layer D remains attached to and is transferred with the electrocatalyst layer, breaking of the layer D effects release. For example, the decal transfer substrate does not require the presence of an additional polymeric release layer to effect release of the electrocatalyst layer, which contributes to the cost of the decal transfer substrate.

In a second aspect, the present invention provides a method of applying an electrocatalyst layer to a surface by transfer from a catalysed decal transfer substrate, wherein the catalysed decal transfer substrate comprises:
i) a decal transfer substrate;
ii) an electrocatalyst layer A;
iii) a layer D between the decal transfer substrate and the electrocatalyst layer A; wherein
   the layer D comprises an ion-conducting polymer and a carbon material;

wherein when the electrocatalyst layer A is transferred to the surface, at least a portion of the layer D remains attached to and is transferred with the electrocatalyst layer A.

In a third aspect, the present invention provides a method of preparing a catalyst coated ion-conducting membrane, the method comprising applying an electrocatalyst layer to a surface of an ion-conducting membrane by the method of the second aspect of the invention.

In a fourth aspect, the present invention provides a method of preparing a membrane electrode assembly, the method comprising the steps of:
i) preparing a catalyst coated ion-conducting membrane by the method of the third aspect of the invention; then
ii) applying a gas diffusion layer to the layer D which remains attached to the electrocatalyst layer.

In a fifth aspect, the present invention provides a method of preparing a catalysed decal transfer substrate, said method comprising the steps of:
a) applying a layer D to a decal transfer substrate; then
b) applying an electrocatalyst layer A to the layer D applied in step a);
   wherein the layer D comprises an ion-conducting polymer and a carbon material.

### BRIEF DESCRIPTION OF THE DRAWINGS

FIG. 1 is a schematic of preparing a catalysed decal transfer substrate according to the invention.

FIG. 2 is a schematic of preparing a catalysed decal transfer substrate according to the invention.

FIG. 3 is a plot showing voltage versus resistance and current density at 100% relative humidity for a membrane electrode assembly comprising an anode electrocatalyst layer applied in accordance with the invention, and a comparative membrane electrode assembly.

### DETAILED DESCRIPTION OF THE INVENTION

Preferred and/or optional features of the invention will now be set out. Any aspect of the invention may be combined with any other aspect of the invention, unless the context demands otherwise. Any of the preferred or optional features of any aspect may be combined, singly or in combination, with any aspect of the invention, unless the context demands otherwise.

As a skilled person will be aware, a decal transfer substrate is a substrate on to which a material can be applied, and then moved therefrom onto a surface by contact between the material and the surface. This movement from the decal transfer substrate onto a surface is a transfer in the context of the present invention. The transfer may be facilitated by, for example, pressure and/or heat. In the present invention, the material moved from the decal transfer substrate onto another surface is the electrocatalyst layer A. The electrocatalyst layer A is not applied directly onto the decal transfer substrate. Rather, it is applied to a layer D which is first applied to the decal transfer substrate. For avoidance of doubt, the layer D is in contact with and adhered or attached to the decal transfer substrate on one of its faces, and in contact with and adhered or attached to the electrocatalyst layer A on its opposite face, separated by the thickness of layer D. Preferably, there are no additional layers separating the layer D from the decal transfer substrate or the electrocatalyst layer A, and a polymeric release layer is not required. The catalysed decal transfer substrate of the invention may be provided as a roll-good material.

Upon transfer of the electrocatalyst layer A onto a surface, for example, the surface of an ion-conducting membrane, the layer D will break such that a portion of the layer D remains attached to and is transferred with the electrocatalyst layer A, and a portion remains attached to the decal transfer substrate. This is preferred. Accordingly, it is preferred that at least a portion of the layer D remains attached to the decal transfer substrate. Alternatively, all of the layer D remains attached to and is transferred with the electrocatalyst layer A.

The requirement that upon transfer of the electrocatalyst layer A to a surface, at least a portion of the layer D remains attached to and is transferred with the electrocatalyst layer A may suitably be achieved as follows. The adhesive strength between the decal transfer substrate and layer D (AS1), the adhesive strength between the electrocatalyst layer A and layer D (AS2), and the cohesive strength of layer D (CS) may have one of the following relationships (i) or (ii):

AS2>CS and AS1>CS and AS2≥AS1; or (i)

CS>AS1 and AS2>AS1. (ii)

Preferably, AS1, AS2 and CS have relationship (i). Adhesive strength has the same units as cohesive strength which, as a skilled person knows, is N/m². The absolute values of AS1, AS2 and CS are not critical providing that they meet the requirements of relationships (i) and (ii), and are such that the parts of the assembly other than the layer D do not break upon transfer. Accordingly, when the electrocatalyst layer A is transferred to a surface the layer D may break along the x-y-plane, i.e. the plane which extends perpendicularly to the thickness (the thickness being the z-plane), of the catalysed decal transfer substrate such that a portion remains attached to and is transferred with the electrocatalyst layer A and at least a portion of the layer D remains attached to the decal transfer substrate (relationship (i)). Alternatively, the entire layer D is transferred with the electrocatalyst layer A (relationship (ii)).

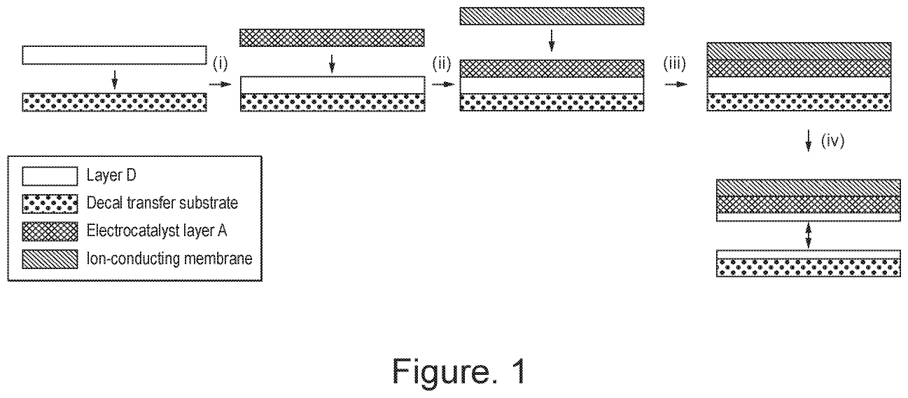

Step (iv) of FIG. 1 schematically illustrates the layer D breaking as part of a process for preparing a catalyst coating ion-conducting membrane according to the third aspect of the invention. The amount and distribution of the portion of layer D which remains attached to and is transferred with the electrocatalyst layer A is not particularly limited providing that enough is transferred for adequate release of the electrocatalyst layer and effective marking of the electrocatalyst layer. Preferably, at least a portion of the layer D remains attached to the decal substrate after transfer. Accordingly, it is preferred that at least a portion but not all of the layer D remains attached to and is transferred with the electrocatalyst layer A. For example, no more than 90%, suitably no more than 60% of the layer D remains attached to and is transferred with the electrocatalyst layer A. Preferably, the portion of the layer D which remains attached to and is transferred with the electrocatalyst layer A is distributed across at least 90% of the surface of the electrocatalyst layer, preferably at least 95%. Suitably, the portion which remains attached to and is transferred with the electrocatalyst layer A is substantially uniform. Put another way, the thinnest portion of the layer is at least 50% as thick as the thickest portion, preferably at least 75% thick, more preferably at least 90% as thick, most preferably at least 95% as thick. The thickness of the layer D is not particularly limited and the thickness of the layer D which remains attached to and is transferred with the electrocatalyst layer A is not particularly limited, providing it does not interfere with the electrochemical activity of the electrocatalyst layer in a membrane electrode assembly. For example, when a substantially uniform portion is transferred, the thickness transferred is no more than 90%, suitably no more than 60% of the thickness of the layer D. By way of example, the thickness of the layer D which remains attached to and is transferred with the electrocatalyst layer A may be at least 0.1 μm and no more than 10 μm, suitably no more than 5 μm, for example no more than 2 μm.

The layer D comprises, preferably consists essentially of, more preferably consists of (or comprises only) an ion-conducting material and a carbon material. The carbon material is preferably in powder form. Suitable carbon materials include carbon blacks, and graphitic materials such as graphitised carbon blacks, graphene, carbon nanofibres, carbon nanotubes and graphite. Preferably, the carbon material is a graphitic material, more preferably the carbon material is graphite, preferably in powder form, for example a synthetic graphite such as Synthetic graphite powder 46304 (Alfa Aesar®) and C-NERGY SFG 6 L graphite (Imerys®). The loading of the carbon material in the layer D may suitably be at least 50 wt % and no more than 95 wt %, preferably no more than 80 wt % by total weight of the layer D. The resulting layer must be electronically conductive. Use of, in particular, graphitic material is especially preferred in the case when it is desirable for the layer D to break, because it is believed, without wishing to be bound by theory, that the poor interaction between the graphitic material and the ion-conducting material (e.g. the ion-conducting material does not adhere well to graphite) forms a weak layer D, i.e. a layer with relatively low CS. Other materials present in layer D, if at all, may include dyes, such as metal oxides, which aid the purpose of marking the electrocatalyst layer but which do not interfere with the electrochemical activity of the electrocatalyst layer. The layer D does not comprise an electrocatalyst.

The ion-conducting material is, suitably, an ion-conducting polymer, preferably a proton conducting ionomer. Accordingly, the electrocatalyst layer A may suitably be for use in a proton exchange membrane fuel cell or electrolyser. A skilled person understands that an ionomer is a polymer composed of both electrically neutral repeating units and ionizable repeating units covalently bonded to the polymer backbone via side-chains. The ion-conducting material may include ionomers such as perfluorosulphonic acid (e.g. Nafion® (Chemours Company), Aciplex® (Asahi Kasei), Aquivion® (Solvay Specialty Polymer), Flemion® (Asahi Glass Co.) and perfluorosulphonic acid ionomer material supplied by 3M®), or ionomers based on partially fluorinated or non-fluorinated hydrocarbon sulphonated or phosphonated polymers, such as those available from FuMA-Tech GmbH as the fumapem® P, E or K series of products, JSR Corporation, Toyobo Corporation, and others.

The decal transfer substrate used in the invention may be formed from any suitable material onto which the layer D can be applied such that there is the required adhesive strength between the layer D and the decal transfer substrate (e.g. it meets the requirements of relationships (i) and (ii) defined above), and the decal substrate can adequately support the electrocatalyst layer. Examples of suitable materials include a fluoropolymer, such as polytetrafluoroethylene (PTFE), ethylene tetrafluoroethylene (ETFE), perfluoroalkoxy polymer (PFA), fluorinated ethylene propylene (FEP)—a copolymer of hexafluoropropylene and tetrafluoroethylene) and polyolefins, such as biaxially oriented polypropylene (BOPP), polyethylene naphthalate (PEN), polyester (PET), polyethyleneimine (PEI), polyimide (PI), polyphenylene sulphide (PPS), polyether ether ketone (PEEK) and polyolefins. These materials can be used in the invention without the need for an additional polymeric release layer. Materials which are considered less expensive substrates include PEN, PET, PEI, PPS, PEEK and polyolefins.

The electrocatalyst layer A comprises an electrocatalyst. The exact electrocatalyst used will depend on the reaction it is intended to catalyse, and its selection is within the capability of the skilled person. The electrocatalyst may be a cathode or an anode electrocatalyst, preferably of a fuel cell or an electrolyser, more preferable a proton exchange membrane fuel cell or electrolyser. The electrocatalyst is suitably selected from:
(i) the platinum group metals (platinum, palladium, rhodium, ruthenium, iridium and osmium);
(ii) gold or silver;
(iii) a base metal;

or an alloy or mixture comprising one or more of these metals or their oxides. A base metal is tin or a transition metal which is not a noble metal. A noble metal is a platinum group metal (platinum, palladium, rhodium, ruthenium, iridium or osmium) or gold. Preferred base metals are copper, cobalt, nickel, zinc, iron, titanium, molybdenum, vanadium, manganese, niobium, tantalum, chromium and tin.

Typically, the electrocatalyst comprises a platinum group metal or an alloy of a platinum group metal, preferably with a base metal, preferred base metals as defined above. In particular, the electrocatalyst comprises platinum or an alloy of platinum with a base metal, preferred base metals as defined above, more preferably nickel or cobalt, most preferably nickel. The atomic ratio of platinum to alloying metal is typically in the range of and including 3:1 to 1:3.

The electrocatalyst layer A may be a cathode or an anode, preferably of a fuel cell or electrolyser, more preferably of a proton exchange membrane fuel cell or electrolyser. The characteristics of the electrocatalyst layer, such as the thickness, electrocatalyst loading, porosity, pore size distribution, average pore size and hydrophobicity will depend on whether it is being used at the anode or cathode. In a fuel cell anode, the electrocatalyst layer thickness is suitably at least 1 μm, typically at least 5 μm. In a fuel cell anode, the electrocatalyst layer thickness is suitably no more than 15 μm, typically no more than 10 μm. In a fuel cell cathode, the electrocatalyst layer thickness is suitably at least 2 μm, typically at least 5 μm. In a fuel cell cathode, the electrocatalyst layer thickness is suitably no more than 20 μm, typically no more than 15 μm.

The electrocatalyst loading in the electrocatalyst layer A will also depend on the intended use. In this context, electrocatalyst loading means the amount of active metal, for example platinum group, in the electrocatalyst layer. So, when the electrocatalyst is an alloy of platinum, e.g. in a fuel cell cathode, the electrocatalyst loading is the amount of platinum per unit area expressed as mg/cm². For example, in a fuel cell cathode containing an electrocatalyst which contains platinum, the electrocatalyst loading is suitably at least 0.05 mgPt/cm², for example no more than 0.5 mgPt/cm², preferably no more than 0.3 mgPt/cm² In a fuel cell anode, the electrocatalyst loading is suitably at least 0.02 mgPt/cm², for example no more than 0.2 mg/Ptcm², preferably no more than 0.15 mgPt/cm².

The electrocatalyst layer A preferably comprises an ion-conducting polymer, such as a proton conducting ionomer, to improve the ion-conductivity of the layer. Accordingly, the ion-conducting material may include ionomers such as perfluorosulphonic acid materials (e.g. Nafion® (Chemours Company), Aciplex® (Asahi Kasei), Aquivion® (Solvay Specialty Polymer), Flemion® (Asahi Glass Co.) and perfluorosulphonic acid ionomer material supplied by 3M®), or ionomers based on partially fluorinated or non-fluorinated hydrocarbons that are sulphonated or phosphonated polymers, such as those available from FuMA-Tech GmbH as the fumapem® P, E or K series of products, JSR Corporation, Toyobo Corporation, and others. Suitably, the ionomer is a perfluorosulphonic acid, in particular the Nafion® range available from Chemours company, especially Nafion® 1100EW, and the Aquivion® range available from Solvay, especially Solvay® 830EW.

The electrocatalyst layer A may comprise additional components. Such components include, but are not limited to: an oxygen evolution catalyst; a hydrogen peroxide decomposition catalyst; a hydrophobic additive (e.g. a polymer such as polytetrafluoroethylene (PTFE) or an inorganic solid with or without surface treatment) or a hydrophilic additive to control reactant and water transport characteristics. The choice of additional components will depend on whether the electrocatalyst layer is for use at the anode or the cathode and it is within the capability of a skilled person to determine which additional components are appropriate.

The catalysed decal transfer substrate of the invention is prepared by first applying a layer D to a decal transfer substrate. To do this, a layer D ink is first prepared. Such an ink may be prepared by dispersing the ion-conducting material, carbon material and any additional components in a diluent which is an aqueous and/or organic solvent. If required, agglomerate particle break-up is carried out by methods known in the art such as high shear mixing, milling, ball milling, passing through a microfluidiser etc. or a combination thereof. Suitable solvents include alcohol based solvents, preferably propanols or ethanol, for example propan-1-ol, including mixtures of alcohol based solvents with water such as, for example, propan-1-ol:water. In mixtures of organic solvents and water, the weight percent of organic solvent by total weight of the diluent is suitably no more than 90 wt % and at least 10 wt %.

The layer D ink may be applied to the decal transfer substrate by any suitable technique known to those in the art. Such techniques include, but are not limited to, gravure coating, slot die (slot, extrusion) coating, screen printing, rotary screen printing, inkjet printing, spraying, painting, bar coating, pad coating, gap coating techniques such as knife or doctor blade over roll, and metering rod application. Preferred techniques are bar coating and slot die. The applied electrocatalyst ink is formed into an electrocatalyst layer by drying. The drying method is not particularly limited, and a skilled person will be able to identify a suitable method which is compatible with the material used in the decal transfer substrate (e.g. is not above its melting temperature). For example, the ink may be heated to a temperature in the range of and including 50 to 250° C.

After the layer D has been applied to the decal transfer substrate, the electrocatalyst layer A is applied to the layer D to form the catalysed decal transfer substrate. To do this, an electrocatalyst ink is first prepared. Such an ink may be prepared by dispersing an electrocatalyst, an ion-conducting material (if required), and any additional components in a diluent which is an aqueous and/or organic solvent. If required, agglomerate particle break-up is carried out by methods known in the art such as high shear mixing, milling, ball milling, passing through a microfluidiser etc. or a combination thereof. Suitable solvents include alcohol based solvents, preferably propanols or ethanol, for example propan-1-ol, including mixtures of alcohol based solvents with water such as, for example ,propan-1-ol:water. In mixtures of organic solvents and water, the weight percent of organic solvent by total weight of the diluent is suitably no more than 90 wt % and at least 10 wt %.

The electrocatalyst ink may be applied to the layer D by any suitable technique known to those in the art. Such techniques include, but are not limited to, gravure coating, slot die (slot, extrusion) coating, screen printing, rotary screen printing, inkjet printing, spraying, painting, bar coating, pad coating, gap coating techniques such as knife or doctor blade over roll, and metering rod application. The applied electrocatalyst ink is formed into an electrocatalyst layer A by drying. The drying method is not particularly limited, and a skilled person will be able to identify a suitable method. For example, the ink may be heated to a temperature in the range of and including 50 to 250° C.

Typical surfaces on to which the electrocatalyst layer A may be transferred include the surfaces of an ion-conducting membrane. A skilled person is aware of ways in which such a transfer can be effected. For example, the catalysed decal transfer substrate and the surface are placed together such that the electrocatalyst layer A is in contact with the surface and pressure is applied before removal of the decal transfer substrate along with, if applicable, a portion of the layer D. Heat may be applied along with pressure, for example temperatures in the range of and including 130° C. to 200° C., suitably 150° C. to 170° C. The pressure and, if required, heat may be applied, for example, using heating rollers or a heated press.

Application of the electrocatalyst layer A to the surface of an ion-conducting membrane in the third aspect of the invention provides a catalyst coated ion-conducting membrane. Both the anode and cathode electrocatalyst layers may be applied using a catalysed decal transfer substrate of the invention, or just one of the anode or cathode may be applied using a catalysed decal transfer substrate of the invention. The second electrocatalyst layer may be already present on the ion-conducting membrane when the electrocatalyst layer A is applied, or may be applied subsequently. In order to mark one electrocatalyst layer so that it can be distinguished from the other, a preferable method involves using the catalysed decal transfer substrate of the invention to apply only one of the anode or the cathode electrocatalyst layers. FIG. 1 shows a method of preparing a catalyst coated ion-conducting membrane according to the third aspect of the invention. In step (i) a layer D is applied to a decal transfer substrate, in step (ii) an electrocatalyst layer A is applied to the layer D, in step (iii) the catalysed decal transfer substrate is combined with an ion-conducting membrane and in step (iv) the decal transfer substrate is removed (i.e. transfer is effected) with a portion of the layer D remaining on the decal transfer substrate, and a portion remaining on the electrocatalyst layer A.

A catalyst coated ion-conducting membrane may also be built up on the catalyst decal transfer substrate before the decal transfer substrate is removed (i.e. before transfer is effected). Accordingly, an ion-conducting membrane as described above is applied to the electrocatalyst layer A. Then, an electrocatalyst layer B is applied to the other surface of ion-conducting membrane, i.e. the surface separated by the thickness of the ion-conducting membrane. Accordingly, the catalysed decal transfer substrate of the invention may additionally comprise:
iv) an ion-conducting membrane; and
v) an electrocatalyst layer B;

wherein the ion-conducting membrane is between the two electrocatalyst layers A and B.

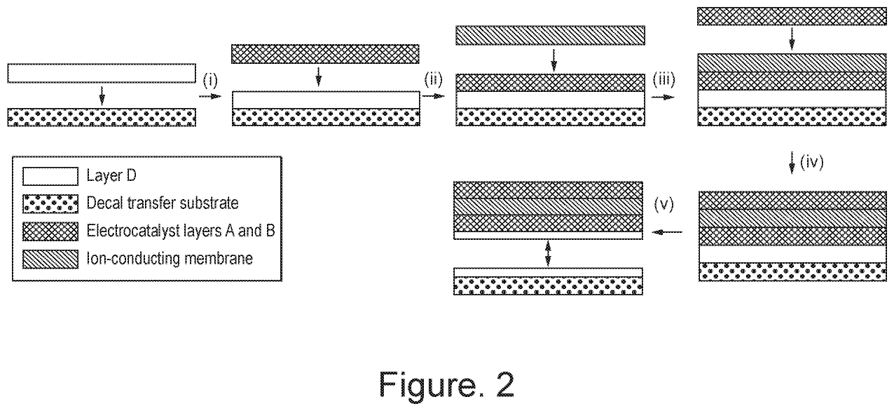

Moreover, the method of the fifth aspect of the invention may further comprise the steps of:
c) applying an ion-conducting membrane to the electrocatalyst layer A;
d) applying an electrocatalyst layer B to the ion-conducting membrane such that the ion-conducting membrane is between the two electrocatalyst layers A and B. The decal transfer substrate is then preferably removed (i.e. transfer is effected) after the electrocatalyst layer B has been applied. FIG. 2 shows a method of preparing a catalyst coated ion-conducting membrane in this fashion. In step (i) a layer D is applied to a decal transfer substrate, in step (ii) an electrocatalyst layer A is applied to the layer D, in step (iii) an ion-conducting membrane is applied to the electrocatalyst layer A, in step (iv) an electrocatalyst layer B is applied to the ion-conducting membrane and in step (v) the decal transfer substrate is removed (i.e. transfer is effected) with a portion of the layer D remaining on the decal transfer substrate, and a portion remaining on the electrocatalyst layer A.

The ion-conducting membrane is suitably in contact with both of the electrocatalyst layers A and B such that the electrocatalyst layers are separated by the thickness of the ion-conducting membrane and no other layers are present which separate the layers. If the electrocatalyst layer A is a cathode, then the electrocatalyst layer B is suitably an anode and vice versa. Features of the electrocatalyst layer B are as described herein for electrocatalyst layer A. The ion-conducting membrane and the electrocatalyst layers can be applied by methods known in the art, including the additive layer manufacturing process described for a catalyst coated membrane-seal assembly described in WO2015/145128. Accordingly, the decal transfer substrate in the present invention may be the carrier referred to in WO2015/154128.

Preferably, in all aspects of the invention, the ion-conducting membrane is any membrane suitable for use in a proton exchange membrane fuel cell or electrolyser, for example the membrane may be based on a perfluorinated sulphonic acid material such as Nafion® (Chemours Company), Aquivion® (Solvay Specialty Polymers), Flemion® (Asahi Glass Group) and Aciplex® (Asahi Kasei Chemicals Corp.). Alternatively, the ion-conducting membrane may be based on a sulphonated hydrocarbon membrane such as those available from FuMA-Tech GmbH as the fumapem® P, E or K series of products, JSR Corporation, Toyobo Corporation, and others.

The thickness of the ion-conducting membrane is not particularly limited and will depend on the intended application of the ion-conducting membrane. For example, typical fuel cell ion-conducting membranes have a thickness of at least 5 μm, suitably at least 8 μm, preferably at least 10 μm. Typical fuel cell ion-conducting membranes have a thickness of no more than 50 μm, suitably no more than 30 μm, preferably no more than 20 μm. Accordingly, typical fuel cell ion-conducting membranes have a thickness in the range of and including 5 to 50 μm, suitably 8 to 30 μm, preferably 10 to 20 μm.

The ion-conducting membrane may comprise additional components such as peroxide decomposition catalysts and/or radical decomposition catalysts, and/or recombination catalysts. Recombination catalysts catalyse the recombination of unreacted H₂ and O₂ which can diffuse into the ion-conducting membrane from the anode and cathode of a fuel cell respectively, to produce water. The ion-conducting membrane may also comprise a reinforcement material, such as a planar porous material (for example expanded polytetrafluoroethylene (ePTFE) as described in USRE37307), embedded within the thickness of the ion-conducting membrane, to provide for improved mechanical strength of the ion-conducting membrane, such as increased tear resistance and reduced dimensional change on hydration and dehydration, and thus further increase the durability of a membrane electrode assembly and lifetime of a fuel cell incorporating the catalysed ion-conducting membrane of the invention. Other approaches for forming reinforced ion-conducting membranes include those disclosed in U.S. Pat. Nos. 7,807,063 and 7,867,669 in which the reinforcement is a rigid polymer film, such as polyimide, into which a number of pores are formed and then subsequently filled with the PFSA ionomer.

Any reinforcement present may extend across the entire thickness of the ion-conducting membrane or may extend across only a part of the thickness of the ion-conducting membrane. It may further be advantageous to reinforce the perimeter of the first and second surface of the ion-conducting membrane to a greater extent than the central face of the first and second surface of the ion-conducting membrane. Conversely, it may be desirable to reinforce the centre of the first or second surface of the ion-conducting membrane to a greater extent than perimeter of the first or second surface of the ion-conducting membrane.

The process for preparing a membrane electrode assembly of the fourth aspect of the invention may suitably be carried out as follows:
(i) applying a gas diffusion layer to the layer D which remains attached to the electrocatalyst layer on one or both faces of a catalyst coated ion-conducting membrane prepared by the third aspect of the invention. Applying a gas diffusion layer to the electrocatalyst layer on the other face of the catalyst coated ion-conducting membrane, if only one electrocatalyst layer was applied by the method of the third aspect of the invention.
(ii) applying a gas diffusion electrode to one face of a catalyst coated ion-conducting membrane prepared by the method of the third aspect of the invention, and applying a gas diffusion layer to the layer D which remains attached to the electrocatalyst layer on the other face.

For avoidance of doubt, the faces of an ion-conducting membrane referred to herein extend along the x-y plane of the ion-conducting membrane and are separated by the thickness of the ion-conducting membrane, which extends in the z-direction.

Accordingly, a membrane electrode assembly may be prepared by applying a gas diffusion layer to electrocatalyst layer B of a catalyst coated ion-conducting membrane which has been prepared by the method of the fifth aspect of the invention, before or after the decal transfer substrate has been removed (i.e. before or after transfer has been effected). After the decal transfer substrate has been removed, a gas diffusion layer may be applied to the layer D which remains attached to and is transferred with the electrocatalyst layer A.

The gas diffusion layer comprises a gas diffusion substrate and, preferably, a microporous layer. Typical gas diffusion substrates include non-woven papers or webs comprising a network of carbon fibres and a thermoset resin binder (e.g. the TGP-H series of carbon fibre paper available from Toray Industries Inc., Japan or the H2315 series available from Freudenberg FCCT KG, Germany, or the Sigracet® series available from SGL Technologies GmbH, Germany or AvCarb® series from Ballard Power Systems Inc.), or woven carbon cloths. The carbon paper, web or cloth may be provided with a pre-treatment prior to fabrication of the electrode and being incorporated into a membrane electrode assembly either to make it more wettable (hydrophilic) or more wet-proofed (hydrophobic). The nature of any treatments will depend on the type of fuel cell and the operating conditions that will be used. The substrate can be made more wettable by incorporation of materials such as amorphous carbon blacks via impregnation from liquid suspensions, or can be made more hydrophobic by impregnating the pore structure of the substrate with a colloidal suspension of a polymer such as PTFE or polyfluoroethylenepropylene (FEP), followed by drying and heating above the melting point of the polymer. Typical microporous layers comprise a mixture of a carbon black and a polymer such as polytetrafluoroethylene (PTFE).

### EXAMPLES

### General Electrocatalyst Layer Ink Preparation

Anode electrocatalyst layer ink (anode ink) was prepared by wetting the anode electrocatalyst material with Solvay 790EW PFSA ionomer dispersed in a 83% water/17% propan-1-ol mix. This mixture was mechanically agitated using an overhead stirrer until all of the catalyst had been wetted and dispersed in the liquid. The ink was then processed through an Eiger ball mill to form a well dispersed ink.

Cathode electrocatalyst layer ink (cathode ink) was prepared by wetting the cathode electrocatalyst material with 3M 825EW PFSA ionomer dispersed in a 20% water/80% propan-1-ol mix. This mixture was mechanically agitated using an overhead stirrer until all of the catalyst had been wetted and dispersed in the liquid. The ink was then processed through an Eiger ball mill to form a well dispersed ink.

### Layer D Ink Preparation

60 g of graphite powder 46304 (Alfa Aesar®) or C-NERGY SFG 6 L (Imerys®) was gently mixed with 11% ultrapure water (18MΩ)/89% propan-1-ol mix, and PFSA ionomer (Nafion® D2020 Chemours) such that the amount of ionomer solid was 20% wt of the graphite mass and the solid content of the ink was 15% wt by total weight of the ink. After all of the graphite was incorporated into the ink the resulting mix was processed using a high shear mixer to ensure that the ionomer material was intimately mixed with the graphite. The mixer used was either a Silverson Mixer Homogeniser, Eiger ball mill or a Microfluidics Microfluidizer.

### Assembly of Inventive Catalysed Decal Transfer Substrate

Layer D ink was coated onto PTFE to form a continuous layer using a bar coating system. The wet layer deposited was 40 μm in thickness. This layer was then dried at 80° C. Then, an anode ink containing a 20 wt % Pt/C electrocatalyst material HiSPEC® 3000 (Johnson Matthey) was coated using a slot die onto the dried layer D.

### Preparation of Membrane Electrode Assemblies

Two catalyst coated ion-conducting membranes of 50 cm² active area were prepared, one according to the invention (MEA1), and one comparative (MEA2).

MEA 1 was prepared by transferring an anode electrocatalyst layer to one face of a reinforced PFSA membrane (15 μm thickness) using the inventive catalysed decal transfer substrate. The anode electrocatalyst layer contained a 20 wt % Pt/C electrocatalyst HiSPEC 3000 (Johnson Matthey) and was transferred at a temperature of between 150° C. to 200° C. and the entirety of the layer D was transferred with the electrocatalyst layer. The cathode electrocatalyst layer contained a 50 wt % Pt/C electrocatalyst HiSPEC® 21710 (Johnson Matthey) using a carbon specifically designed for fuel cell applications as disclosed in WO2013/015894, and was formed from a cathode ink on a PTFE sheet and transferred to the opposite face of the ion-conducting membrane a temperature of between 150° C. to 200° C. and. The cathode had a loading of 0.4 mgPt/cm² and the anode had a loading 0.08 mgPt/cm².

MEA 2 was prepared by forming an anode electrocatalyst layer on a PTFE sheet using an anode ink and transferring the electrocatalyst layer, which contained a 20 wt % Pt/C electrocatalyst HiSPEC 3000 (Johnson Matthey), to one face of a reinforced PFSA membrane (15 μm thickness) at a temperature of between 150° C. to 200° C. The cathode electrocatalyst layer contained a 50 wt % Pt/C electrocatalyst HiSPEC® 21710 (Johnson Matthey) using a carbon specifically designed for fuel cell applications as disclosed in WO2013/015894, and was formed from a cathode ink on a PTFE sheet and transferred to the opposite face of the ion-conducting membrane at a temperature of between 150° C. to 200° C. and. The cathode had a loading of 0.4 mgPt/cm² and the anode had a loading 0.08 mgPt/cm².

A gas diffusion layer was applied to each face of each catalyst coated ion-conducting membrane to form the complete membrane electrode assemblies. The gas diffusion layer used was a carbon fibre paper with a hydrophobic microporous layer containing carbon and PTFE (Sigracet® 39BC from SGL Technologies GmbH) applied to the face in contact with the catalyst coated ion-conducting membrane.

### Electrochemical Testing Method

The polarisation (current vs voltage) performance of each of MEA1 and MEA2 was measured in H₂/air at 80° C. under fully humidified and pressurised (100% RH, 100 kPag) conditions using H₂ and air flows at a stoichiometries of 1.5 and 2.0 respectively. The cell humidity (RH) and pressure were controlled at the anode and cathode inlets.

### Results and Discussion

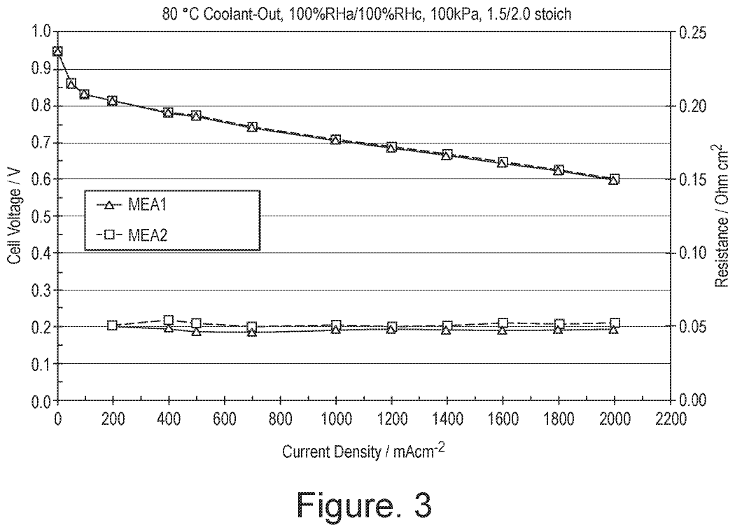

FIG. 3 shows the polarisation performance and resistance of both MEA 1 and MEA 2. It can be seen that the performance of the two parts is identical and this is repeated across all conditions. This means that layer D can used as a means of identification of an electrocatalyst layer, as well as to facilitate transfer of the electrocatalyst layer, without altering the performance of the membrane electrode assembly.

1-11. (canceled)

12. A catalysed decal transfer substrate comprising:
i) a decal transfer substrate;
ii) an electrocatalyst layer A;
iii) a layer D between the decal transfer substrate and the electrocatalyst layer A;
wherein
the layer D comprises an ion-conducting polymer and a carbon material; and
the layer D is configured such that, upon transfer of the electrocatalyst layer A to a surface, at least a portion of the layer D remains attached to and is transferred with the electrocatalyst layer A.

13. A catalysed decal transfer substrate according to claim 12, wherein the layer D is configured such that, upon transfer of the electrocatalyst layer D to a surface, at least a portion of the layer D remains attached to the decal transfer substrate.

14. A catalysed decal transfer substrate according to claim 12, wherein the adhesive strength between the decal transfer substrate and layer D (AS1), the adhesive strength between the electrocatalyst layer A and layer D (AS2), and the cohesive strength of layer D (CS) have one of the following relationships (i) or (ii):
AS2>CS and AS1>CS and AS2≥AS1; or (i)
CS>AS1 and AS2>AS1. (ii)

15. A catalysed decal transfer substrate according to claim 12, further comprising:
iv) an ion-conducting membrane; and
v) an electrocatalyst layer B;
wherein the ion-conducting membrane is between the two electrocatalyst layers A and B.

16. A roll-good material comprising the catalysed decal transfer substrate according to claim 12.

17. A method of applying an electrocatalyst layer to a surface by transfer from a catalysed decal transfer substrate, wherein the catalysed decal transfer substrate comprises:
i) a decal transfer substrate;
ii) an electrocatalyst layer A;
iii) a layer D between the decal transfer substrate and the electrocatalyst layer A;
wherein
the layer D comprises an ion-conducting polymer and a carbon material;
wherein when the electrocatalyst layer A is transferred to the surface, at least a portion of the layer D remains attached to and is transferred with the electrocatalyst layer A.

18. A method according to claim 17, wherein when the electrocatalyst layer A is transferred to the surface, at least a portion of the layer D remains attached to the decal transfer substrate.

19. A method of preparing a catalyst coated ion-conducting membrane, the method comprising applying an electrocatalyst layer to a surface of an ion-conducting membrane by the method of claim 17.

20. A method of preparing a membrane electrode assembly, the method comprising the steps of:
i) preparing a catalyst coated ion-conducting membrane by the method of claim 19;
ii) applying a gas diffusion layer to the layer D which remains attached to the electrocatalyst layer.

21. A method of preparing a catalysed decal transfer substrate, the method comprising the steps of:
a) applying a layer D to a decal transfer substrate; then
b) applying an electrocatalyst layer A to the layer D applied in step a); wherein the layer D comprises an ion-conducting polymer and a carbon material.

22. A method according to claim 21, further comprising the steps of:
c) applying an ion-conducting membrane to the electrocatalyst layer A;
d) applying an electrocatalyst layer B to the ion-conducting membrane such that the ion-conducting membrane is between the two electrocatalyst layers A and B.

23. A catalysed decal transfer substrate according to claim 12, wherein a loading of the carbon material in the layer D is at least 50 wt % and no more than 95 wt %.

24. A catalyst decal transfer substrate according to claim 12, wherein the carbon material is a carbon black or a graphitic material.
